(19) United States
(12) Patent Application Publication
(10) Pub. No.: US 2015/0207774 A1
(43) Pub. Date: Jul. 23, 2015

(54) Method and System of APP for Obtaining MAC Address of Terminal

(71) Applicant: CHENDU SKSPRUCE TECHNOLOGY, INC., Chengdu, Sichuan (CN)

(72) Inventors: Fang Wu, Chengdu (CN); Kaidi Huang, Chengdu (CN); Yongcheng Lei, Chengdu (CN); Jiangang Ding, Chengdu (CN); Jingli Chi, Chengdu (CN)

(21) Appl. No.: 14/421,025

(22) PCT Filed: May 4, 2014
(86) PCT No.: PCT/CN2014/076703

§ 371 Date: Feb. 11, 2015

(30) Foreign Application Priority Data
Dec. 23, 2013 (CN) 201310717996.3

(51) Int. Cl. H04L 29/12

(52) U.S. Cl. CPC H04L 61/1552; H04L 61/6022

(57) ABSTRACT

The invention relates to the field of communication, and particularly to a method and a system for an application (APP) to obtain a media access control (MAC) address of a terminal. The method comprises: sending a request of MAC address inquiry to an access network through a local terminal; receiving a response of MAC address inquiry returned from the access network through the local terminal, with the response of MAC address inquiry carrying MAC address information of the local terminal, the MAC address information obtained by the access network during communication between the local terminal and the access network. According to the method and the system for the APP to obtain the MAC address of the terminal of the present invention, the MAC address information of the local terminal is obtained through the access network as a third-party server, and then the APP inquiries to the access network, and lastly the access network notifies the MAC address information to the APP, which solves the problem in the prior art that the way for the APP to directly obtain the MAC address of the terminal is shielded by the operating system.

### TECHNICAL FIELD

The present invention relates to the field of communication, and particularly to a method and a system for an application (APP) to obtain a media access control (MAC) address of a terminal.

### BACKGROUND ART

At present, terminals, such as mobile phones, tablet computers and the like, have become necessities of people's daily life. Usually a terminal is loaded with applications (hereinafter referred to as APP) to enrich functions of the terminal. And a network server can indirectly obtain a user's interests and demands by detecting the user's operations to the APP in the terminal, thus pushing different customized information to different terminals according to the user's interests and demands.

In order to achieve the function that the network server pushes to the terminal information that may meet a user's demands, it is necessary for the APP to obtain a MAC address of the terminal and notify the same to the network server. In the related art, the terminal firstly registers MAC address information of this terminal in a registry table of the terminal, wherein when the APP needs to obtain the MAC address of the terminal, it is carried out through a running instruction input interface provided by a terminal operating system, wherein the APP inputs through this interface an instruction for obtaining the MAC address, and then it can obtain the MAC address of the terminal from the registry table of the terminal.

However, in terminals using certain systems, such as the terminal using IOS7 system, the terminal does not provide the running instruction input interface, that is to say, the way for the APP to obtain the MAC address of the terminal is shielded, thus the APP is unable to obtain the MAC address of the terminal, and then the network server can not obtain the MAC address of the terminal, can not distinguish different terminals, and is unable to achieve the function of pushing different customized information to different terminals.

### DISCLOSURE OF THE INVENTION

An object of the present invention is to provide a method and a system for an APP to obtain a MAC address of a terminal, so as to solve the above problems.

An embodiment of the present invention provides a method for an APP to obtain a MAC address of a terminal, the method comprising the following steps: sending a request of MAC address inquiry to an access network through a local terminal; receiving a response of MAC address inquiry returned from the access network through the local terminal; enabling the response of MAC address inquiry to carry MAC address information of the local terminal, with the MAC address information obtained by the access network during communication between the local terminal and the access network.

Preferably, before the step of sending the request of MAC address inquiry to the access network through the local terminal, the method further comprises: sending a request of domain name parsing to the access network through the local terminal, with the request of domain name parsing containing the domain name to be parsed, which is pre-stored in the APP; and receiving a response of domain name parsing returned from the access network through the local terminal, with the response of domain name parsing carrying IP address of an apparatus in the access network responsible for answering the request of MAC address inquiry, with the IP address pre-configured in the access network.

Preferably, the step of obtaining the MAC address information by the access network during communication between the local terminal and the access network comprises: obtaining the MAC address information from the request of MAC address inquiry sent from the local terminal to the access network.

Preferably, the step of obtaining the MAC address information by the access network during communication between the local terminal and the access network comprises: obtaining the MAC address information from messages exchanged during the local terminal being associated with the access network.

Preferably, returning the response of MAC address inquiry from the access network comprises: determining the MAC address information corresponding to the local terminal which sends the request of MAC address inquiry, by the access network, according to source IP address or source MAC address carried in the request of MAC address inquiry and pre-built corresponding relation between the source IP address or the source MAC address and the MAC address information of the local terminal; and

enabling the message of the response of MAC address inquiry to carry the MAC address information corresponding to the local terminal which sends the request of MAC address inquiry, and returning the same to the local terminal which sends the request of MAC address inquiry.

Another embodiment of the present invention provides a system for an APP to obtain a MAC address of a terminal, the system comprising the APP, a local terminal and an access network, wherein the APP is used for sending a request of MAC address inquiry to the access network through the local terminal, and for receiving a response of MAC address inquiry returned from the access network through the local terminal, MAC address information of the local terminal is carried in the response of MAC address inquiry, wherein the MAC address information is obtained by the access network during communication between the local terminal and the access network.

Preferably, in the system for the APP to obtain the MAC address of the terminal, the APP is also used for sending a request of domain name parsing to the access network through the local terminal and receiving a response of domain name parsing returned from the access network through the local terminal, wherein the request of domain name parsing contains the domain name to be parsed, which is pre-stored in the APP, and IP address of an apparatus in the access network responsible for answering the request of MAC address inquiry is carried in the response of domain name parsing, with the IP address being pre-stored in the access network.

Preferably, the access network is specifically used for receiving the request of MAC address inquiry sent from the local terminal, and obtaining the MAC address information from the request of MAC address inquiry sending from the local terminal to the access network.

Preferably, the access network is specifically used for building association with the local terminal, and obtaining the MAC address information from messages exchanged during the local terminal being associated with the access network.

Preferably, the access network is specifically used for determining the MAC address information corresponding to the local terminal which sends the request of MAC address inquiry, according to source IP address or source MAC address carried in the request of MAC address inquiry and pre-built corresponding relation between the source IP address or the source MAC address and the MAC address information of the local terminal; and enabling the message of the response of MAC address inquiry to carry the MAC address information corresponding to the local terminal which sends the request of MAC address inquiry, and returning the same to the local terminal which sends the request of MAC address inquiry.

In the method and the system for the APP to obtain the MAC address of the terminal according to the present invention, the MAC address information of the local terminal is obtained through the access network used as a third party server, and then the APP inquiries to the access network, and lastly the access network notifies the MAC address information to the APP. Here, the method used is different from that in the prior art where the APP directly obtains it from the local terminal, therefore said method solves the problem in the prior art that the way for the APP to directly obtain the MAC address of the terminal is shielded by the operating system.

In the above embodiments of the present invention, the way for the APP to obtain the MAC address of the terminal is re-established, without depending on the running instruction input interface, wherein the MAC address of the local terminal is obtained through the access network during its communication with the local terminal and in addition, when the access network receives the request of MAC address inquiry sent from the APP, the access network puts the MAC address of the local terminal obtained during its communication with the local terminal into the response of MAC address inquiry returned from the access network to the APP, such that the APP can obtain the MAC address of the terminal. Afterwards, the local terminal can send the MAC address to a network server, and then the network server can obtain the MAC address of the terminal, distinguish different terminals based on the MAC address of the terminal, and achieve the function of pushing different customized information to different terminals.

### BRIEF DESCRIPTION OF DRAWINGS

FIG. 1 illustrates a flowchart of a method for an APP to obtain a MAC address of a terminal provided by the present invention;

FIG. 2 illustrates a flowchart of a method for an APP to obtain a MAC address of a terminal provided by the present invention;

FIG. 3 illustrates a signaling flowchart of a method for an APP to obtain a MAC address of a terminal provided by the present invention;

FIG. 4 illustrates a signaling flowchart of a method for an APP to obtain a MAC address of a terminal provided by the present invention; and

FIG. 5 illustrates a structural schematic view of a system for an APP to obtain a MAC address of a terminal provided by the present invention.

### DETAILED DESCRIPTION OF EMBODIMENTS

Hereinafter, the present invention will be further described in detail by means of specific embodiments in conjunction with the figures.

As shown in FIG. 1, an embodiment of the present invention provides a method for an APP to obtain a MAC address of a terminal, using the APP as the body to perform the method which comprises the following steps:

Step S110: sending a request of MAC address inquiry to an access network through a local terminal.

In particular, in the step S110, the APP sends the access network messages, any of which should be sent through the local terminal which is the one containing the APP, possibly a mobile phone, a notebook PC or a tablet computer. The access network may be a WiFi access network. In the present invention, the access network may be regarded as a router, the request of MAC address inquiry is sent by the APP to the access network through the local terminal, and the terminal can communicate with the access network, which means that the local terminal has accessed to the access network. The address that the request of MAC address inquiry is sent to can either be specified in advance by the local terminal or discovered automatically by the local terminal.

Step S120: receiving a response of MAC address inquiry returned from the access network through the local terminal, wherein MAC address information of the local terminal is carried in the response of MAC address inquiry, and the MAC address information is obtained by the access network during communication between the local terminal and the access network.

Optionally, in the step S120, this communication process can be any communication process between the local terminal and the access network, such as the process of the local terminal being associated to the access network or the process of the local terminal sending the request of MAC address inquiry to the access network, which is not limited here. The MAC address information can also be obtained from the messages exchanged during the local terminal being associated with the access network.

As for obtaining the MAC address information from messages exchanged during the local terminal being associated to the access network, optionally, the MAC address information can be obtained during any handshake process between the local terminal and the access network, such as scanning, authentication and association.

In the present embodiment, the access network can obtain the MAC address information through the request of MAC address inquiry, eliminating the process of obtaining the MAC address information during the local terminal being associated to the access network, and also the access network can obtain it during the process of the local terminal being associated to the access network, increasing flexibility of the access network obtaining the MAC address information.

Preferably, in the step S120, the access network returning the response of MAC address inquiry comprises: the access network determines the MAC address information corresponding to the local terminal which sends the request of MAC address inquiry, according to source IP address or source MAC address carried in the request of MAC address inquiry and pre-built corresponding relation between the source IP address or the source MAC address and the MAC address information of the local terminal; and the message of the response of MAC address inquiry is enabled to carry the MAC address information corresponding to the local terminal which sends the request of MAC address inquiry, and be returned to the local terminal which sends the request of MAC address inquiry.

When returning the response of MAC address inquiry using the above manners, it is able to determine the MAC address information corresponding to the local terminal which sends the request of MAC address inquiry, not only according to the source IP address carried in the request of MAC address inquiry and the corresponding relation between the source IP address and the MAC address information of the local terminal, but also through the source MAC address and the pre-built corresponding relationship between the source MAC address and the MAC address information of the local terminal, such that the access network can determine the MAC address information of the local terminal in either manner, greatly increasing the flexibility for the access network to obtain the MAC address information of the local terminal.

In the method for the APP to obtain the MAC address of the terminal of the above embodiment of the present invention, the MAC address information of the local terminal is obtained through the local terminal and the access network used as a third party server, and then the APP inquiries to the access network, and lastly the access network notifies the MAC address information to the APP, which is a method different from that in the prior art in which the APP directly obtains it from the local terminal, with this method solving the problem in the prior art that the way for the APP to obtain the MAC address of the terminal is shielded. The way for the APP to obtain the MAC address of the terminal is re-established, without depending on the running instruction input interface, such that the MAC address of the local terminal is obtained through the access network during its communication with the local terminal. In addition, when the access network receives the request of MAC address inquiry sent from the APP, the access network puts the MAC address of the local terminal obtained during its communication with the local terminal into the response of MAC address inquiry it returns to the APP, such that the APP obtains the MAC address of the terminal, and the local terminal sends the MAC address to a network server, and then the network server can obtain the MAC address of the terminal, distinguish different terminals based on the MAC address of the terminal, and achieve the function of pushing different customized information to different terminals.

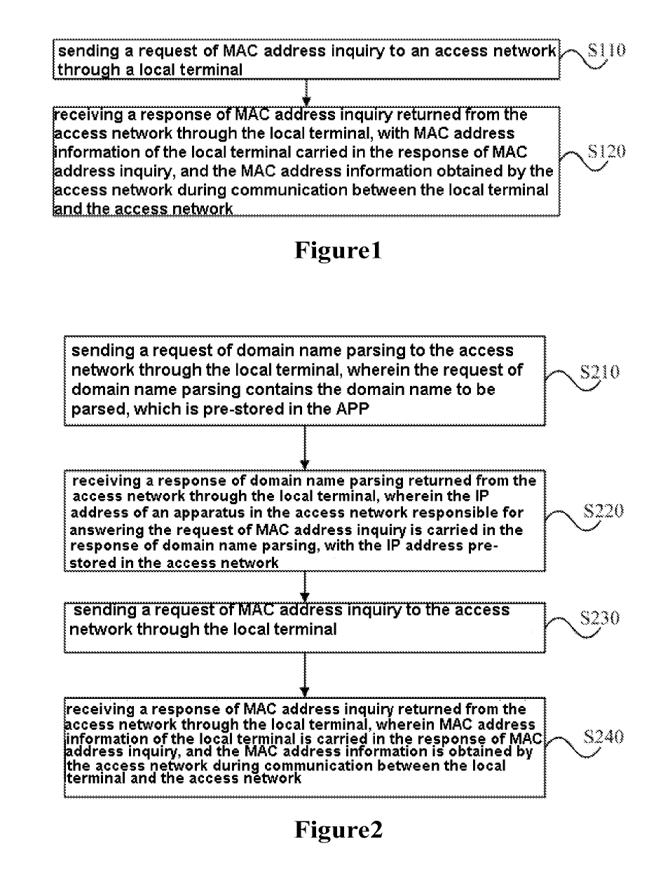

As shown in FIG. 2, another embodiment of the present invention also provides a method for an APP to obtain a MAC address of a terminal, and the method is an implementation method, in which the address that the request of MAC address inquiry is sent to is discovered automatically by the local terminal, specifically comprising the following steps:

Step S210: sending a request of domain name parsing to the access network through the local terminal, wherein the request of domain name parsing contains the domain name to be parsed, which is pre-stored in the APP.

In particular, the domain name to be parsed may be www.whatismymac.com, which is pre-stored in the APP.

Usually, the access network would receive a plurality of requests of domain name parsing, and the domain name to be parsed in the request of domain name parsing may be pre-stored or not stored in the APP. As for the request of domain name parsing carrying the domain name to be parsed and not stored in the APP, the access network forwards the request of domain name parsing directly to a corresponding domain name parsing system to parse, so as to obtain the corresponding MAC address, which will not be introduced herein. As for the request of domain name parsing carrying the domain name to be parsed and pre-stored in the APP, the access network ends the request of domain name parsing after monitoring the same. Before this, the access network needs to obtain in advance the domain name to be parsed, which is pre-stored in the APP.

Step S220: receiving a response of domain name parsing returned from the access network through the local terminal, wherein the IP address of an apparatus in the access network responsible for answering the request of MAC address inquiry is carried in the response of domain name parsing, with the IP address pre-stored in the access network.

In practical applications, the access network has two functions, one is of being responsible for access of a user, and the other is of providing the response to the request of MAC address inquiry.

Step S230: sending a request of MAC address inquiry to the access network through the local terminal.

Step S240: receiving a response of MAC address inquiry returned from the access network through the local terminal, wherein MAC address information of the local terminal is carried in the response of MAC address inquiry, and the MAC address information is obtained by the access network during communication between the local terminal and the access network.

The introduction of the steps S110 and S120 of the embodiment shown in FIG. 1 may be referred to for the implementation principle of the steps S230 and S240.

In the method for the APP to obtain the MAC address of the terminal provided by the present embodiment, the IP address in the access network responsible for answering service is automatically discovered by the APP, eliminating the step of the local terminal pre-configuring the address that the request of MAC address inquiry is sent to. As long as the local terminal triggers an access request of a domain name to be parsed and the domain name to be parsed is pre-stored in the APP, a procedure of obtaining the IP address of an apparatus in the access network responsible for answering the request of MAC address inquiry is started. After the local terminal obtains the IP address of the apparatus in the access network responsible for answering the request of MAC address inquiry, the APP can send the request of MAC address inquiry to the IP address.

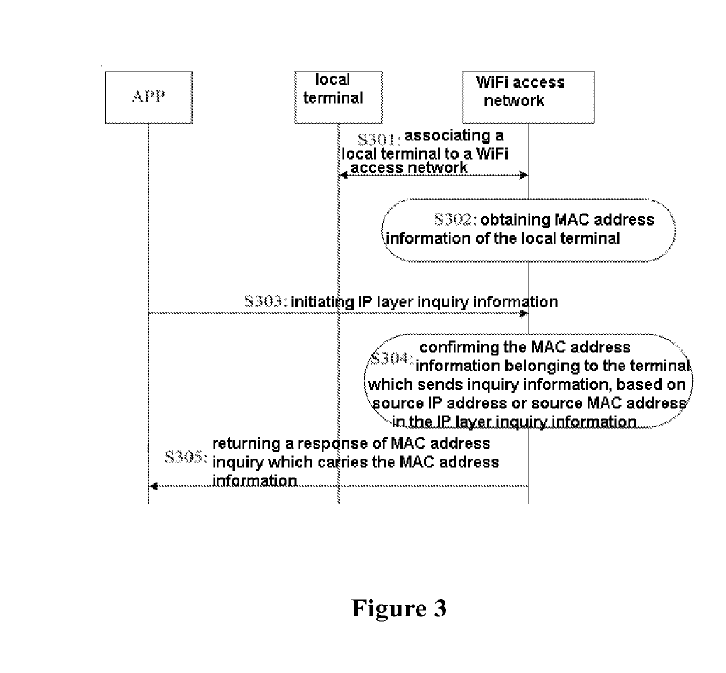

FIG. 3 is a signaling flowchart of a method for an APP to obtain a MAC address of a terminal provided by the present invention. In the present embodiment, a local terminal and an access network coordinate with each other for implementation, as an application example, in which the APP, with the help of the access network, through data exchange of an IP layer, obtains MAC address information of the local terminal. The method comprises the following steps:

Step S301: associating a local terminal to a WiFi access network;

Step S302: the WiFi access network obtaining MAC address information of the local terminal during the association;

Step S303: the APP inquiring the MAC address information of the local terminal through the local terminal initiating IP layer inquiry information to the WiFi access network;

Step S304: the WiFi access network confirming the MAC address information belonging to the terminal which sends inquiry information, based on source IP address or source MAC address in the IP layer inquiry information;

Step S305: the access network returning to the APP the MAC address information carried in a response of MAC address inquiry.

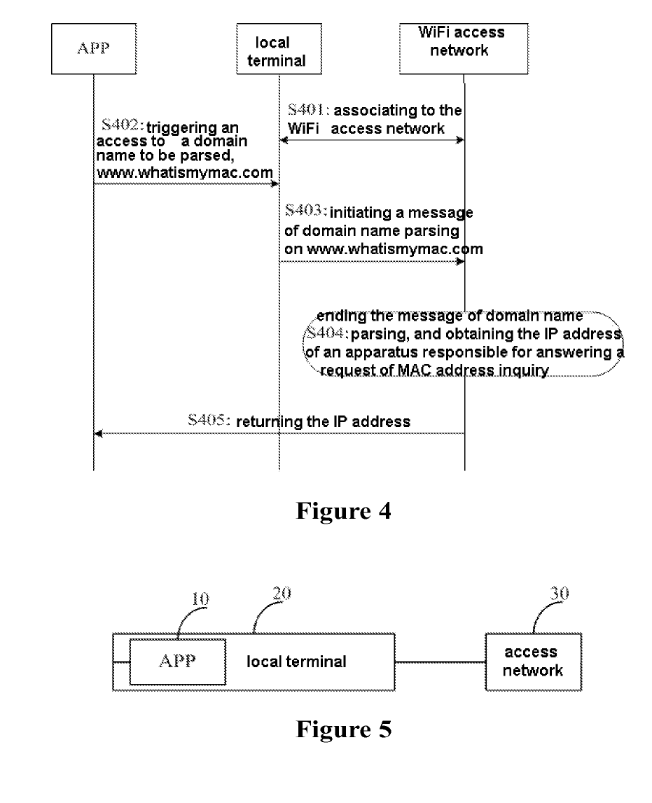

FIG. 4 illustrates a signaling flowchart of a method of the present invention in which an APP automatically obtains IP address in a WiFi access network responsible for answering service of MAC address inquiry. The method particularly comprises the following steps:

Step S401: associating a local terminal to the WiFi access network;

Step S402: the APP triggering an access to a domain name to be parsed, wherein for example, the domain name to be parsed is www.whatismymac.com;

Step S403: the local terminal initiating a message of domain name parsing about www.whatismymac.com;

Step S404: the access network ending the message of domain name parsing, and obtaining the IP address of an apparatus responsible for answering a request of MAC address inquiry;

Step S405: returning the IP address to the APP.

As shown in FIG. 5, another embodiment of the present invention provides a system for an APP to obtain a MAC address of a terminal, the system comprising the APP 10, a local terminal 20 and an access network 30, wherein the APP 10 is used for sending a request of MAC address inquiry to the access network 30 through the local terminal 20 and receiving a response of MAC address inquiry returned from the access network 30 through the local terminal 20, wherein MAC address information of the local terminal 20 is carried in the response of MAC address inquiry, and the MAC address information is obtained by the access network 30 during communication between the local terminal 20 and the access network 30.

The system provided by the present embodiment may implement the method for the APP 10 to obtain the MAC address of the terminal of the present invention, to produce the corresponding functions and beneficial effects, which will not be described further.

Preferably, the system for the APP 10 to obtain the MAC address of the terminal is further configured such that: the APP 10 sends a request of domain name parsing to the access network 30 through the local terminal 20 with the request of domain name parsing containing the domain name to be parsed, which is pre-stored in the APP 10; and the APP 10 receives a response of domain name parsing returned from the access network 30 through the local terminal 20, with the response of domain name parsing carrying the IP address of an apparatus in the access network 30 responsible for answering the request of MAC address inquiry, the IP address pre-configured in the access network 30.

Preferably, the local terminal 20 sends a request of MAC address inquiry to the access network 30, and the MAC address information is obtained from the request of MAC address inquiry sent from the local terminal 20 to the access network 30.

Preferably, the local terminal 20 builds association with the access network 30, and the MAC address information is obtained from messages exchanged during the local terminal 20 being associated with the access network 30.

Preferably, the response of MAC address inquiry returned from the access network 30 is specifically as follows. The access network 30 is specifically used for determining the MAC address information corresponding to the local terminal 20 which sends the request of MAC address inquiry, according to source IP address or source MAC address carried in the request of MAC address inquiry and the pre-built corresponding relation between the source IP address or the source MAC address and the MAC address information of the local terminal 20; and enabling the message of the response of MAC address inquiry to carry the MAC address information corresponding to the local terminal 20 which sends the request of MAC address inquiry, and returning the same to the local terminal 20 which sends the request of MAC address inquiry.

The system for the APP to obtain the MAC address of the terminal provided by the present invention may implement the technical solution of any embodiment of the methods shown in FIGS. 1 to 4, with similar implementation principle and technical effects, which will not be described further.

The above description is merely for preferable embodiments of the present invention, instead of limiting the invention. The ordinary person skilled in the art can make various changes and variations to the present invention. Any amendments, equivalents, and improvements are covered by the protection scope of the present invention, without departing from the spirit and scope of the present invention.

1. A method for an APP to obtain a MAC address of a terminal, characterized by comprising the following steps:
sending a request of MAC address inquiry to an access network through a local terminal; and
receiving through the local terminal a response of MAC address inquiry returned from the access network,
the response of MAC address inquiry carrying MAC address information of the local terminal,
the MAC address information obtained by the access network during communication between the local terminal and the access network.

2. The method according to claim 1, characterized in that before the step of sending the request of MAC address inquiry to the access network through the local terminal, it further comprises:
sending a request of domain name parsing to the access network through the local terminal, with the request of domain name parsing containing the domain name to be parsed, which is pre-stored in the APP; and
receiving through the local terminal a response of domain name parsing returned from the access network, with the response of domain name parsing carrying IP address of an apparatus in the access network responsible for answering the request of MAC address inquiry, the IP address pre-configured in the access network.

3. The method according to claim 1, characterized in that the step of the access network obtaining the MAC address information during communication between the local terminal and the access network comprises: obtaining the MAC address information during the request of MAC address inquiry sent from the local terminal to the access network.

4. The method according to claim 1, characterized in that the step of the access network obtaining the MAC address information during communication between the local terminal and the access network comprises: obtaining the MAC address information from messages exchanged during the local terminal being associated to the access network.

5. The method according to claim 1, characterized in that the access network returning the response of MAC address inquiry comprises:
the access network determining the MAC address information corresponding to the local terminal which sends the request of MAC address inquiry, according to source IP address or source MAC address carried in the request of MAC address inquiry and pre-built corresponding relation between the source IP address or the source MAC address and the MAC address information of the local terminal; and
enabling the message of the response of MAC address inquiry to carry the MAC address information corresponding to the local terminal which sends the request of MAC address inquiry, and returning the same to the local terminal which sends the request of MAC address inquiry.

6. A system for an APP to obtain a MAC address of a terminal characterized by comprising the APP, a local terminal and an access network, wherein
the APP is used for sending a request of MAC address inquiry to the access network through the local terminal and receive a response of MAC address inquiry returned from the access network through the local terminal;
MAC address information of the local terminal is carried in the response of MAC address inquiry, and
the MAC address information is obtained by the access network during communication between the local terminal and the access network.

7. The system according to claim 6, characterized in that the APP is also used for:
sending a request of domain name parsing to the access network through the local terminal, with the request of domain name parsing containing the domain name to be parsed, which is pre-stored in the APP, and
receiving a response of domain name parsing returned from the access network through the local terminal, wherein the IP address of an apparatus in the access network responsible for answering the request of MAC address inquiry is carried in the response of domain name parsing, with the IP address pre-stored in the access network.

8. The system according to claim 6, characterized in that the access network is specifically used for receiving the request of MAC address inquiry sent from the local terminal, and obtaining the MAC address information from the request of MAC address inquiry sent from the local terminal to the access network.

9. The system according to claim 6, characterized in that the access network is specifically used for building association with the local terminal, and obtaining the MAC address information from messages exchanged during the local terminal being associated to the access network.

10. The system according to claim 6, characterized in that the access network is specifically used for determining the MAC address information corresponding to the local terminal which sends the request of MAC address inquiry, according to source IP address or source MAC address carried in the request of MAC address inquiry and pre-built corresponding relation between the source IP address or the source MAC address and the MAC address information of the local terminal, and
enabling the message of the response of MAC address inquiry to carry the MAC address information corresponding to the local terminal which sends the request of MAC address inquiry, and returning the same to the local terminal which sends the request of MAC address inquiry.
